(19) United States
(12) Patent Application Publication
(10) Pub. No.: US 2026/0333234 A1
(43) Pub. Date: Oct. 22, 2026

(54) INFORMATION MEASUREMENT METHOD, TERMINAL, AND NETWORK-SIDE DEVICE

(71) Applicant: VIVO MOBILE COMMUNICATION CO., LTD., Dongguan (CN)

(72) Inventors: Yi WANG, Dongguan (CN); Xin QU, Dongguan (CN); Lihui WANG, Dongguan (CN); Li CHEN, Dongguan (CN)

(73) Assignee: VIVO MOBILE COMMUNICATION CO., LTD., Dongguan (CN)

(21) Appl. No.: 19/704,371

(22) Filed: Jun. 10, 2026

Related U.S. Application Data
(63) Continuation of application No. PCT/CN2024/137791, filed on Dec. 9, 2024.

(30) Foreign Application Priority Data
Dec. 13, 2023 (CN) 202311720011.2

(51) Int. Cl. H04W 52/02; H04W 24/08; H04W 56/00

(52) U.S. Cl. CPC H04W 52/0235; H04W 24/08; H04W 56/001

(57) ABSTRACT

An information measurement method, a terminal, and a network-side device are provided. The information measurement method includes: A low power wake up receiver (LP-WUR) of a terminal receives a first signal, where the first signal includes a low-power synchronization signal (LP-SS) or a synchronization signal block (SSB); the terminal measures the first signal to obtain a first measurement result; and the terminal determines a second measurement result based on the first measurement result, where the second measurement result includes at least one of a beam-level measurement result or a cell-level measurement result.

### CROSS-REFERENCE TO RELATED APPLICATIONS

This application is a continuation of International Application No. PCT/CN2024/137791, filed Dec. 9, 2024, which claims priority to Chinese Patent Application No. 202311720011.2, filed Dec. 13, 2023. The entire contents of each of the above-referenced applications are expressly incorporated herein by reference.

### TECHNICAL FIELD

This application pertains to the field of communication technologies, and in particular, to an information measurement method, a terminal, and a network-side device.

### BACKGROUND

In a conventional communication system, to meet a low-power communication requirement of a terminal, a Low Power Wake Up Receiver (LP-WUR) may be introduced into the terminal. A basic working principle of the LP-WUR is as follows: The terminal includes a first module and a second module. The first module is a main communication module, and may be configured to receive communication data transmitted by a transmitting end and send communication data. The second module is a low-power module, and may be configured to receive a Low power wake-up signal (LP-WUS) and a Low power Synchronization Signal (LP-SS). The low-power wake-up signal may be used to wake up the main communication module, and the low-power synchronization signal may be used to provide time reference information and other information for receiving the low-power wake-up signal.

In the related art, when communicating with a network-side device based on the LP-WUR, the terminal may perform signal transmission based on multiple beams. In a multi-beam scenario, after receiving, based on the LP-WUR, a signal sent by the network-side device, the terminal usually needs to perform channel quality measurement based on the received signal. However, no relevant solution is available to achieve such an objective.

### SUMMARY

Embodiments of this application provide an information measurement method, a terminal, and a network-side device.

According to a first aspect, an information measurement method is provided. The method is performed by a terminal and includes:
a low power wake up receiver LP-WUR of the terminal receives a first signal, where the first signal includes a low-power synchronization signal LP-SS or a synchronization signal block SSB;
the terminal measures the first signal to obtain a first measurement result; and
the terminal determines a second measurement result based on the first measurement result, where the second measurement result includes at least one of a beam-level measurement result or a cell-level measurement result.

According to a second aspect, an information measurement method is provided. The method is performed by a network-side device and includes:

The network-side device sends a first signal.

The first signal includes an LP-SS or an SSB, the first signal is used for measurement by a terminal to obtain a first measurement result, the first measurement result is used to determine a second measurement result, and the second measurement result includes at least one of a beam-level measurement result or a cell-level measurement result.

According to a third aspect, an information measurement apparatus is provided. The apparatus includes:
a receiving module, configured to receive a first signal, where the first signal includes a low-power synchronization signal LP-SS or a synchronization signal block SSB;
a measurement module, configured to measure the first signal to obtain a first measurement result; and
a determining module, configured to determine a second measurement result based on the first measurement result, where the second measurement result includes at least one of a beam-level measurement result or a cell-level measurement result.

According to a fourth aspect, an information measurement apparatus is provided. The apparatus includes:
a sending module, configured to send a first signal.

The first signal includes an LP-SS or an SSB, the first signal is used for measurement by a terminal to obtain a first measurement result, the first measurement result is used to determine a second measurement result, and the second measurement result includes at least one of a beam-level measurement result or a cell-level measurement result.

According to a fifth aspect, a terminal is provided. The terminal includes a processor and a memory, and the memory stores a program or instructions that can be run on the processor. The program or the instructions are executed by the processor to implement the steps of the method according to the first aspect.

According to a sixth aspect, a terminal is provided, including a processor and a communication interface. The communication interface is configured to receive a first signal. The first signal includes a low-power synchronization signal LP-SS or a synchronization signal block SSB. The processor is configured to measure the first signal to obtain a first measurement result, and determine a second measurement result based on the first measurement result. The second measurement result includes at least one of a beam-level measurement result or a cell-level measurement result.

According to a seventh aspect, a network-side device is provided. The network-side device includes a processor and a memory, and the memory stores a program or instructions that can be run on the processor. The program or the instructions are executed by the processor to implement the steps of the method according to the second aspect.

According to an eighth aspect, a network-side device is provided, including a processor and a communication interface. The communication interface is configured to send a first signal. The first signal includes an LP-SS or an SSB, the first signal is used for measurement by a terminal to obtain a first measurement result, the first measurement result is used to determine a second measurement result, and the second measurement result includes at least one of a beam-level measurement result or a cell-level measurement result.

According to a ninth aspect, a readable storage medium is provided. The readable storage medium stores a program or instructions, and when the program or the instructions are executed by a processor, the steps of the method according to the first aspect are implemented, or the steps of the method according to the second aspect are implemented.

According to a tenth aspect, a wireless communication system is provided, including a terminal and a network-side device, where the terminal may be configured to perform the steps of the method according to the first aspect, and the network-side device may be configured to perform the steps of the method according to the second aspect.

According to an eleventh aspect, a chip is provided. The chip includes a processor and a communication interface, the communication interface is coupled to the processor, and the processor is configured to run a program or instructions to implement the method according to the first aspect or the method according to the second aspect.

According to a twelfth aspect, a computer program/program product is provided. The computer program/program product is stored in a storage medium, and the program/program product is executed by at least one processor to implement the steps of the method according to the first aspect or the steps of the method according to the second aspect.

In embodiments of this application, when receiving the LP-SS or the SSB, the LP-WUR of the terminal may measure the LP-SS or the SSB, and determine, based on a measurement result, at least one of the beam-level measurement result or the cell-level measurement result. Therefore, in a multi-beam scenario, when communicating with a network-side device based on the LP-WUR, the terminal may achieve a purpose of measuring channel quality based on a received signal.

### BRIEF DESCRIPTION OF DRAWINGS

FIG. 1 is a diagram of a wireless communication system according to an embodiment of this application;

FIG. 2 is a schematic flowchart of an information measurement method according to an embodiment of this application;

FIG. 3 is a diagram of activating and deactivating different reception schemes of an LP-WUR according to an embodiment of this application;

FIG. 4 is a schematic flowchart of an information measurement method according to an embodiment of this application;

FIG. 5 is a diagram of a structure of an information measurement apparatus according to an embodiment of this application;

FIG. 6 is a diagram of a structure of an information measurement apparatus according to an embodiment of this application;

FIG. 7 is a diagram of a structure of a communication device according to an embodiment of this application;

FIG. 8 is a diagram of a structure of a terminal according to an embodiment of this application; and

FIG. 9 is a diagram of a structure of a network-side device according to an embodiment of this application.

### DETAILED DESCRIPTION

The following clearly describes the technical solutions in embodiments of this application with reference to the accompanying drawings in embodiments of this application. Apparently, the described embodiments are some but not all the embodiments of this application. All other embodiments obtained by a person of ordinary skill in the art based on embodiments of this application shall fall within the protection scope of this application.

Terms such as “first” and “second” in this application are used to distinguish between similar objects, and are not used to describe a specific order or sequence. It should be understood that, the terms used in such a way are interchangeable in proper circumstances, so that embodiments of this application can be implemented in an order other than the order illustrated or described herein. Objects classified by “first” and “second” are usually of a same type, and a quantity of objects is not limited. For example, there may be one or more first objects. In addition, “or” in this application indicates at least one of the connected objects. For example, “A or B” covers three scenarios, namely scenario 1: including A but not B; scenario 2: including B but not A; and scenario 3: including both A and B. The character “/”generally indicates that associated objects are in an “OR” relationship.

The term “indication” in this application may be either a direct indication (or an explicit indication) or an indirect indication (or an implicit indication). The direct indication may be understood as that, in the indication sent, a sender explicitly informs a receiver of content such as specific information, an operation to be performed, or a request result. The indirect indication may be understood as that, based on the indication sent by the sender, the receiver determines corresponding information, or performs determining and determines, based on a determining result, an operation to be performed, a request result, or the like.

It should be noted that technologies described in embodiments of this application are not limited to a Long Term Evolution (LTE)/LTE-advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), or another system. The terms “system” and “network” in embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to systems other than the NR system, such as the 6^{th} Generation (6G) communication system.

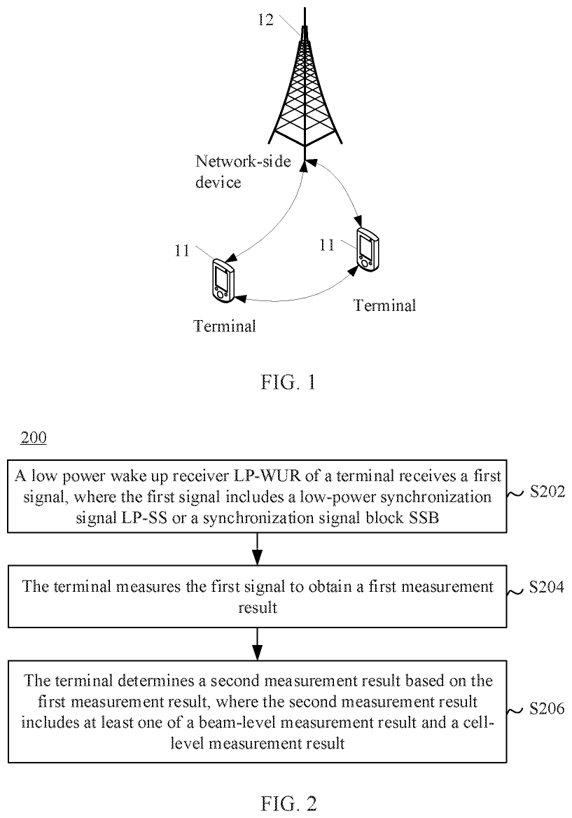

FIG. 1 is a block diagram of a wireless communication system to which embodiments of this application may be applied. The wireless communication system includes a terminal 11 and a network-side device 12. The terminal 11 may be a terminal side device such as a mobile phone, a tablet personal computer, a laptop computer, a notebook computer, a Personal Digital Assistant (PDA), a palmtop computer, a netbook, an Ultra-mobile Personal Computer (UMPC), a Mobile Internet Device (MID), an Augmented Reality (AR) device, a Virtual Reality (VR) device, a robot, a wearable device, a flight vehicle, Vehicle User Equipment (VUE), ship-borne equipment, Pedestrian User Equipment (PUE), a smart home (a home device with a wireless communication function, such as a refrigerator, a television, a washing machine, or furniture), a game console, a personal computer (PC), a teller machine, or a self-service machine. The wearable device includes: a smart watch, a smart band, a smart headset, smart glasses, smart jewelry (a smart bracelet, a smart hand chain, a smart ring, a smart necklace, a smart anklet, a smart ankle chain), a smart wristband, smart clothing, and the like. The vehicle user equipment may also be referred to as an in-vehicle terminal, an in-vehicle controller, an in-vehicle module, an in-vehicle component, an in-vehicle core, an in-vehicle unit, or the like. It should be noted that a specific type of the terminal 11 is not limited in embodiments of this application. The network-side device 12 may include an access network device or a core network device. The access network device may also be referred to as a radio access network (RAN) device, a radio access network function, or a radio access network unit. The access network device may include a base station, a Wireless Local Area Network (WLAN) Access Point (AP), a Wireless Fidelity (Wi-Fi) node, or the like. The base station may be referred to as a NodeB (Node B, NB), an evolved NodeB (eNB), a next-generation NodeB (gNB), a new radio NodeB (NR Node B), an access point, a relay station (RBS), a serving base station (SBS), a base transceiver station (BTS), a radio base station, a radio transceiver, a basic service set (BSS), an extended service set (ESS), a home NodeB (HNB), a home evolved NodeB, a Transmission Reception Point (TRP), or another appropriate term in the field. As long as a same technical effect is achieved, the base station is not limited to a specified technical term. It should be noted that, in embodiments of this application, only a base station in an NR system is used as an example, and a specific type of the base station is not limited.

With reference to the accompanying drawings, the following describes in detail an information measurement method, a terminal, and a network-side device in embodiments of this application based on some embodiments and application scenarios thereof.

As shown in FIG. 2, an embodiment of this application provides an information measurement method 200. The method may be performed by a terminal. In other words, the information measurement method may be performed by software or hardware installed in the terminal. The information measurement method includes the following steps.
S202: A low power wake up receiver LP-WUR of the terminal receives a first signal, where the first signal includes a low-power synchronization signal LP-SS or a synchronization signal block SSB.

The terminal includes the Low Power Wake Up Receiver (LP-WUR). In a multi-beam scenario, the LP-WUR of the terminal may receive the first signal. The first signal may be sent by a network-side device. The first signal may be the Low power Synchronization Signal (LP-SS), or the synchronization signal block (SS/PBCH Block, SSB), or the LP-SS and the SSB. In the multi-beam scenario, when the LP-WUR of the terminal receives the first signal, a reception scheme may be omnidirectional reception.
S204: The terminal measures the first signal to obtain a first measurement result.

After receiving the first signal, the terminal may measure the first signal to obtain a measurement result. Herein, for ease of differentiation, the measurement result may be represented as the first measurement result. Measurement of the first signal by the terminal may be measurement of the first signal by the LP-WUR of the terminal.

In some implementations, that the terminal measures the first signal may include any one of the following (1) to (3):
(1) In a case that the terminal supports an LP-SS measurement by the LP-WUR, measuring the LP-SS.

For example, if the LP-WUR of the terminal supports only reception of an on-off keying (OOK) sequence, the terminal supports the LP-SS measurement by the LP-WUR. That is, the LP-WUR of the terminal is capable of performing measurement based on the LP-SS. In this case, the measurement of the first signal by the terminal may be measurement of the LP-SS.
(2) In a case that the terminal supports an SSB measurement by the LP-WUR, measuring the SSB.

For example, if the LP-WUR of the terminal supports only reception of an orthogonal frequency division multiplexing (OFDM) sequence, the terminal supports the SSB measurement by the LP-WUR. That is, the LP-WUR of the terminal is capable of performing measurement based on the SSB. In this case, the measurement of the first signal by the terminal may be measurement of the SSB.
(3) In a case that the terminal supports an LP-SS measurement by the LP-WUR and the SSB, determining a to-be-measured signal from the LP-SS and the SSB based on configuration information of the network-side device; and measuring the to-be-measured signal.

In a case that the LP-WUR of the terminal supports an OFDM sequence reception, or supports an OFDM sequence reception and an OOK reception scheme, the terminal supports the LP-SS measurement and the SSB measurement by the LP-WUR. That is, the LP-WUR of the terminal is capable of performing measurement based on the LP-SS and the SSB. In this case, whether the terminal measures the LP-SS or the SSB may be configured by the network-side device. That is, the terminal may determine, based on the configuration information of the network-side device, the to-be-measured signal, and then measure the to-be-measured signal.

The configuration information of the network-side device may be used for any one of the following:
indicating to measure the LP-SS;
indicating to measure the SSB;
indicating to measure any one of the LP-SS or the SSB;
indicating to measure the LP-SS and the SSB; or
indicating to determine the to-be-measured signal according to a first rule.

In a case that the configuration information indicates to measure the LP-SS, the terminal may measure the LP-SS. In a case that the configuration information indicates to measure the SSB, the terminal may measure the SSB. In a case that the configuration information indicates to measure any one of the LP-SS or the SSB, the terminal may determine, at its discretion, to measure the LP-SS or the SSB. In a case that the configuration information indicates to measure the LP-SS and the SSB, the terminal may measure the LP-SS and the SSB. In a case that the configuration information indicates to determine the to-be-measured signal according to a first rule, the terminal may determine the to-be-measured signal from the LP-SS and the SSB according to the first rule, and measure the to-be-measured signal. The first rule may be a predefined rule. When determining the to-be-measured signal according to a first rule, for example, if the LP-WUR of the terminal supports the reception of the OFDM sequence, and an SSB available for measurement exists in an operating bandwidth of the LP-WUR (for example, an NCD-SSB (Non-Cell Defining SSB) is located in the operating bandwidth of the LP-WUR), the terminal may measure the SSB. Otherwise, the LP-SS may be measured.

The configuration information of the network-side device may be terminal-specific signaling or signaling specific to a terminal group (for example, a terminal group that supports the reception of the OFDM sequence) or cell-specific signaling. The signaling specific to the terminal group may be sent via unicast, multicast, or broadcast. The configuration information may be an explicit configuration or an implicit configuration. For example, if the network-side device configures, in system information, the LP-SS but does not configure an OFDM sequence used for the LP-SS, or does not configure the LP-SS, it may be considered that the network-side device implicitly configures that the terminal with the LP-WUR based on the reception of the OFDM sequence measures the SSB instead of the LP-SS.

In some implementations, in a case that the configuration information is used to indicate to measure the LP-SS and the SSB, the configuration information is further used to configure a first threshold and a second threshold. The first threshold is a threshold used by the terminal to activate or deactivate the LP-WUR based on a measurement result of the LP-SS, the second threshold is a threshold used by the terminal to activate or deactivate the LP-WUR based on a measurement result of the SSB. The first threshold and the second threshold may be the same or different. That is, the network-side device may configure a same threshold or different thresholds for the LP-SS and the SSB.

After measuring the first signal, the terminal may obtain a corresponding first measurement result. In a case that the terminal measures the LP-SS, the first measurement result is the measurement result of the LP-SS. In a case that the terminal measures the SSB, the first measurement result is the measurement result of the SSB. In a case that the terminal measures the LP-SS and the SSB, the first measurement result is the measurement result of the SSB. The first measurement result may include a channel quality measurement result of a cell. In some implementations, the channel quality measurement result of the cell may include at least one of a Radio Link Monitor (RLM) measurement result, a Radio Resource Management (RRM) measurement result, a Channel State Information (CSI) measurement result, or another form of measurement result (for example, a correct demodulation probability) that can reflect the channel quality of the cell. The cell may include at least one of a serving cell or a neighboring cell.

In some implementations, the first measurement result of the LP-SS may include measurement results corresponding to different transmission occasion sets. One transmission occasion set includes one or more transmission occasions, and a transmission occasion may be a transmission occasion of the LP-SS. In some implementations, the first measurement result of the LP-SS may include a measurement result corresponding to an LP-SS of an LP-SS index.

In some implementations, the measurement result of the SSB may include a measurement result corresponding to an SSB of an SSB index. The SSB herein may be an SSB indicated in ssb-PositionsInBurst, or an SSB configured by the network-side device for measurement performed by the LP-WUR, or an SSB to be measured that is configured when a synchronization signal block measurement timing configuration (SS/PBCH block Measurement Timing Configuration, SMTC) is configured.
S206: The terminal determines a second measurement result based on the first measurement result, where the second measurement result includes at least one of a beam-level measurement result or a cell-level measurement result.

After measuring the first signal and obtaining the first measurement result, the terminal may determine the second measurement result based on the first measurement result. The second measurement result may be the beam-level measurement result, or the cell-level measurement result, or the beam-level measurement result and the cell-level measurement result. The beam-level measurement result may be a beam-level measurement result of the LP-SS, or the SSB, or the LP-SS and the SSB. The cell-level measurement result may be a cell-level measurement result of the LP-SS, or the SSB, or the LP-SS and the SSB.

In some implementations, in a case that the first measurement result includes the channel quality measurement result of the cell, the second measurement result may include a channel quality measurement result of a cell. The channel quality measurement result of the cell includes at least one of an RLM measurement result, an RRM measurement result, a CSI measurement result, or another form of measurement result (for example, a correct demodulation probability) that can reflect the channel quality of the cell. The cell may include at least one of a serving cell or a neighboring cell. The second measurement result corresponds to the first measurement result. For example, the first measurement result is an RRM measurement result of the LP-SS, and the second measurement result is a beam-level RRM measurement result or a cell-level RRM measurement result of the LP-SS.

In some implementations, determining the second measurement result based on the first measurement result may include at least one of the following:
determining the beam-level measurement result based on the first measurement result; or
determining the cell-level measurement result based on the beam-level measurement result.

That is, in a case that the second measurement result is the beam-level measurement result, the beam-level measurement result may be determined based on the first measurement result. In a case that the second measurement result includes the cell-level measurement result, the beam-level measurement result may be first determined based on the first measurement result, and then the cell-level measurement result may be derived based on the beam-level measurement result.

When the beam-level measurement result is determined based on the first measurement result, in some implementations, in a case that the first signal includes the LP-SS and the first measurement result includes the measurement results corresponding to different transmission occasion sets or the measurement result corresponding to the LP-SS of the LP-SS index, the terminal may separately generate a beam-level measurement result for different transmission occasion sets and a beam-level measurement result for different LP-SS indexes index. Any one of the following may be included:
combining measurement results of the LP-SS in a first transmission occasion, and determining a combination result as the beam-level measurement result, where the first transmission occasion is a transmission occasion, within different target time periods, corresponding to a same transmission occasion set;
combining measurement results of the LP-SS in second transmission occasions, and determining a combination result as the beam-level measurement result, where the second transmission occasions are transmission occasions, within a same target time period, corresponding to a same transmission occasion set;
determining a measurement result of the LP-SS in a third transmission occasion as the beam-level measurement result, where the third transmission occasion is any one of transmission occasions, within a same target time period, corresponding to a same transmission occasion set;
combining measurement results, within different target time periods, corresponding to an LP-SS of a same LP-SS index, and determining a combination result as the beam-level measurement result;
combining measurement results, within a same target time period, corresponding to an LP-SS of a same LP-SS index, and determining a combination result as the beam-level measurement result; or
determining any one of measurement results, within a same target time period, corresponding to an LP-SS of a same LP-SS index as the beam-level measurement result.

The target time period may be a period of measuring the LP-SS, or an integer multiple of the period of measuring the LP-SS. This is not specifically limited herein. When the measurement results of the LP-SS are combined, the measurement results of the LP-SS may be superimposed, for example, weighted averaged.

In some other implementations, when the terminal determines the beam-level measurement result based on the first measurement result, in a case that the first signal includes the SSB and the first measurement result includes the measurement result corresponding to the SSB of the SSB index, the terminal may separately generate a beam-level measurement result for different SSB indexes index. Any one of the following may be included:
combining measurement results, within different target time periods, corresponding to an SSB of a same SSB index, and determining a combination result as the beam-level measurement result;
combining measurement results, within a same target time period, corresponding to an SSB of a same SSB index, and determining a combination result as the beam-level measurement result; or
determining any one of measurement results, within a same target time period, corresponding to an SSB of a same SSB index as the beam-level measurement result.

The target time period may be a period of measuring the SSB, or an integer multiple of the period of measuring the SSB. This is not specifically limited herein. When the measurement results of the SSB are combined, the measurement results of the SSB may be superimposed, for example, weighted averaged.

After the beam-level measurement result of the LP-SS or the SSB is obtained based on the first measurement result, in some implementations, determining the cell-level measurement result of the LP-SS or the SSB based on the beam-level measurement result may include any one of the following:
determining a measurement result of a beam with the best beam quality as the cell-level measurement result;
determining a measurement result of a beam with the poorest beam quality as the cell-level measurement result;
determining measurement results of a plurality of beams as the cell-level measurement result;
determining a measurement result of M1 beams with the best beam quality as the cell-level measurement result;
determining a measurement result of a beam whose beam quality is greater than a third threshold as the cell-level measurement result;
determining a measurement result of M2 beams whose beam quality is greater than the third threshold as the cell-level measurement result; or
determining a measurement result of a beam with the poorest beam quality in beams whose beam quality is greater than the third threshold as the cell-level measurement result.

Both M1 and M2 are integers greater than 0 and less than or equal to a total quantity of beams, and may be defined by a standard or configured by the network-side device. This is not specifically limited herein. The third threshold may be defined by a standard or configured by the network-side device. This is not specifically limited herein.

Based on the method described in S202 to S206, in the multi-beam scenario, when communicating with the network-side device based on the LP-WUR, the terminal may achieve a purpose of measuring channel quality based on a received signal.

In some implementations, after the terminal obtains the second measurement result based on the first measurement result of the LP-SS or the SSB, the following steps may be further included:

The terminal determines, based on at least one of a power state, the second measurement result, or a third measurement result, to activate or deactivate the LP-WUR in the terminal.

The third measurement result includes a measurement result of the SSB measured by a Main Radio (MR) in the terminal. The SSB herein may be the same as or different from the SSB received in S202. This is not specifically limited. The measurement result of the SSB measured by the MR may include at least one of the beam-level measurement result or the cell-level measurement result. The measurement result of the SSB measured by the MR may include a channel quality measurement result of a cell, and the channel quality measurement result of the cell may include at least one of an RLM measurement result, an RRM measurement result, a CSI measurement result, or another form of measurement result (for example, a correct demodulation probability) that can reflect the channel quality of the cell. The cell may include at least one of a serving cell or a neighboring cell.

The LP-WUR in the terminal may support one or more reception schemes, and different reception schemes correspond to different power consumption and different receiving performance. In a case that the LP-WUR supports one reception scheme, the one reception scheme may be the OOK reception scheme, an OFDM reception scheme, or the like. In a case that the LP-WUR supports a plurality of reception schemes, the plurality of reception schemes may include at least the OOK reception scheme and an OFDM reception scheme. In this way, that the terminal determines, based on at least one of the power state or a coverage status (for example, the second measurement result and the third measurement result), to activate or deactivate the LP-WUR in the terminal may include:
in a case that the LP-WUR supports one reception scheme, determining, based on at least one of the power state, the second measurement result, or the third measurement result, to activate or deactivate the LP-WUR; and
in a case that the LP-WUR supports a plurality of reception schemes, determining, based on at least one of the power state, the second measurement result, or the third measurement result, to activate one of the reception schemes or deactivate the LP-WUR.

In a case that the LP-WUR supports one reception scheme, activation or deactivation of the LP-WUR may be activation or deactivation of the one reception scheme supported by the LP-WUR, and in a case that the one reception scheme is activated or deactivated, the LP-WUR is activated or deactivated. In a case that the LP-WUR supports a plurality of reception schemes, only one of the reception schemes is allowed to be activated at a time. In this way, activation of the LP-WUR may be activation of one of the reception schemes supported by the LP-WUR, and in this case, the remaining schemes is in a deactivated state; and deactivation may be deactivation of all the reception schemes supported by the LP-WUR, and in a case that all the reception schemes supported by the LP-WUR are deactivated, the LP-WUR is deactivated.

In some implementations, the power state of the terminal may be a low battery state or a normal battery state. When the terminal determines, based on the power state, to activate or deactivate the LP-WUR, if the power state is the low battery state, the terminal may activate the LP-WUR, or if the power state is the normal battery state, the terminal may deactivate the LP-WUR. When the LP-WUR is activated, if the LP-WUR supports one reception scheme, the one reception scheme may be activated or deactivated; or if the LP-WUR supports a plurality of reception schemes, one of the reception schemes may be activated. A specific reception scheme to be activated may be determined by the terminal, or may be predefined. This is not specifically limited herein.

In some implementations, in a case that the LP-WUR of the terminal supports one or more reception schemes, that the terminal determines, based on at least one of the second measurement result or the third measurement result, to activate or deactivate the LP-WUR may include:
determining, based on at least one of the beam-level measurement result in the second measurement result or a beam-level measurement result in the third measurement result, to activate or deactivate the LP-WUR;
determining, based on at least one of the beam-level measurement result in the second measurement result or a cell-level measurement result in the third measurement result, to activate or deactivate the LP-WUR;
determining, based on at least one of the cell-level measurement result in the second measurement result or the beam-level measurement result in the third measurement result, to activate or deactivate the LP-WUR; and
determining, based on at least one of the cell-level measurement result in the second measurement result or the cell-level measurement result in the third measurement result, to activate or deactivate the LP-WUR.

That is, when determining to activate or deactivate the LP-WUR, the terminal may perform determining based on the beam-level measurement result, or perform determining based on the cell-level measurement result, or perform determining based on both the beam-level measurement result and the cell-level measurement result. The beam-level measurement result may be at least one of the beam-level measurement result in the second measurement result (that is, the beam-level measurement result of the LP-SS or the SSB by the LP-WUR) or the beam-level measurement result in the third measurement result (that is, the beam-level measurement result of the SSB measured by the MR). The cell-level measurement result may be at least one of the cell-level measurement result in the second measurement result (that is, the cell-level measurement result of the LP-SS or the SSB by the LP-WUR) or the cell-level measurement result in the third measurement result (that is, the cell-level measurement result of the SSB measured by the MR).

Determining, based on at least one of the beam-level measurement result in the second measurement result or the beam-level measurement result in the third measurement result, to activate or deactivate the LP-WUR may include:
in a case that the beam-level measurement result in the second measurement result is greater than or equal to a sixth threshold or the beam-level measurement result in the third measurement result is greater than or equal to a seventh threshold, determining to activate the LP-WUR; and
in a case that the beam-level measurement result in the second measurement result is less than an eighth threshold or the beam-level measurement result in the third measurement result is less than a ninth threshold, determining to deactivate the LP-WUR.

When determining to activate or deactivate the LP-WUR, the beam-level measurement result of the LP-SS or the SSB by the LP-WUR may be compared with the sixth threshold and the eighth threshold, and the beam-level measurement result of the SSB measured by the MR may be compared with the seventh threshold and the ninth threshold. If a comparison result is that the beam-level measurement result of the LP-SS or the SSB by the LP-WUR is greater than or equal to the sixth threshold, or the beam-level measurement result of the SSB measured by the MR is greater than or equal to the seventh threshold, the LP-WUR may be activated. If a comparison result is that the beam-level measurement result of the LP-SS or the SSB by the LP-WUR is less than the eighth threshold or the beam-level measurement result of the SSB measured by the MR is less than the ninth threshold, the LP-WUR may be deactivated.

The sixth threshold and the eighth threshold may be the same or different. That is, when determining, based on the beam-level measurement result in the second measurement result, to activate or deactivate the LP-WUR, the thresholds used may be the same or different. In a different case, the sixth threshold may be greater than the eighth threshold. The seventh threshold and the ninth threshold may be the same or different. That is, when determining, based on the beam-level measurement result in the third measurement result, to activate or deactivate the LP-WUR, the thresholds used may be the same or different. In a different case, the seventh threshold may be greater than the ninth threshold. In addition, the sixth threshold may be the same as or different from the seventh threshold, and the eighth threshold may be the same as or different from the ninth threshold.

Magnitudes of the sixth threshold, the seventh threshold, the eighth threshold, and the ninth threshold may be defined by a standard or configured by the network-side device. This is not specifically limited herein.

There may be one or more manners of determining the beam-level measurement result in the second measurement result. In a case that there is a plurality of determining manners, a manner of determining the beam-level measurement result used for determining, based on the beam-level measurement result in the second measurement result, to activate the LP-WUR and a manner of determining the beam-level measurement result used for determining, based on the beam-level measurement result in the second measurement result, to deactivate the LP-WUR may be the same or different. For example, the second measurement result is the beam-level measurement result of the LP-SS. When the beam-level measurement result of the LP-SS is determined, the combination result of the measurement results, in the same target time period, corresponding to the LP-SS of the same LP-SS index may be determined as the beam-level measurement result, or the combination result of the measurement results, within different target time periods, corresponding to the LP-SS of the same LP-SS index may be determined as the beam-level measurement result. In this case, when determining whether to activate or deactivate the LP-WUR, whether to activate the LP-WUR may be determined based on the combination result of the measurement results, in the same target time period, corresponding to the LP-SS of the same LP-SS index, and whether to deactivate the LP-WUR may be determined based on the combination result of the measurement results, within different target time periods, corresponding to the LP-SS of the same LP-SS index, or whether to activate or deactivate the LP-WUR may be determined based on the combination result of the measurement results, in the same target time period, corresponding to the LP-SS of the same LP-SS index, or whether to activate or deactivate the LP-WUR may be determined based on the combination result of the measurement results, within different target time periods, corresponding to the LP-SS of the same LP-SS index.

There may be one or more manners of determining the beam-level measurement result in the third measurement result. In a case that there are a plurality of determining manners, a manner of determining the beam-level measurement result used for determining, based on the beam-level measurement result in the third measurement result, to activate the LP-WUR and a manner of determining the beam-level measurement result used for determining, based on the beam-level measurement result in the third measurement result, to deactivate the LP-WUR are the same or different. Details are not described herein again.

In a multi-beam scenario, there may be a plurality of beam-level measurement results in the second measurement result and a plurality of beam-level measurement results in the third measurement result. When the beam-level measurement result in the second measurement result or the third measurement result is compared with a threshold, the threshold may be one threshold, or may be a group of thresholds (Each of the thresholds may correspond to one beam, and is used for comparison with a measurement result of the one beam). That is, the sixth threshold, the seventh threshold, the eighth threshold, or the ninth threshold may be one threshold or a group of thresholds.

The sixth threshold is used as an example. In a case that the sixth threshold is one threshold, when the beam-level measurement result in the second measurement result is compared with the sixth threshold, the measurement results of the plurality of beams may be separately compared with the sixth threshold. In a case that the sixth threshold is a group of thresholds, when the beam-level measurement result in the second measurement result is compared with the sixth threshold, a measurement result of each of the beams may be compared with a corresponding sixth threshold. In a case that the sixth threshold is one threshold, the beam-level measurement result in the second measurement result being greater than or equal to the sixth threshold may be measurement results of Z1 beams being greater than or equal to the sixth threshold, or an average value of the measurement results of the plurality of beams being greater than or equal to the sixth threshold, where Z1 is an integer greater than 0 and less than or equal to the total quantity of beams, and may be determined by the terminal, defined by a standard, or configured by the network-side device. In a case that the sixth threshold is a group of thresholds, the beam-level measurement result in the second measurement result being greater than or equal to the sixth threshold may be measurement results of Z2 beams being greater than or equal to a corresponding sixth threshold, where Z2 is an integer greater than 0 and less than or equal to the total quantity of beams, and may be the same as or different from Z1 and may be determined by the terminal, defined by a standard, or configured by the network-side device.

When determining, based on at least one of the beam-level measurement result in the second measurement result or the cell-level measurement result in the third measurement result, to activate or deactivate the LP-WUR, or when determining, based on at least one of the cell-level measurement result in the second measurement result or the beam-level measurement result in the third measurement result, to activate or deactivate the LP-WUR, or when determining, based on at least one of the cell-level measurement result in the second measurement result or the cell-level measurement result in the third measurement result, to activate or deactivate the LP-WUR, the measurement result may be compared with a corresponding threshold and it may be determined, based on a comparison result, to activate or deactivate the LP-WUR. Reference may be made to the foregoing implementation of determining, based on at least one of the beam-level measurement result in the second measurement result or the beam-level measurement result in the third measurement result, to activate or deactivate the LP-WUR. Details are not described herein again. When determining, based on the cell-level measurement result, to activate or deactivate the LP-WUR, if there are a plurality of manners of determining the cell-level measurement result, a manner of determining the cell-level measurement result used for determining whether to activate the LP-WUR may be the same as or different from a manner of determining the cell-level measurement result used for determining whether to deactivate the LP-WUR. Determining, based on the cell-level measurement result in the second measurement result, to activate or deactivate the LP-WUR is used as an example. If, when determining the cell-level measurement result, a measurement result of one beam with the best quality may be determined as the cell-level measurement result, and a measurement result of a beam with the poorest quality in beams beyond a threshold may be determined as the cell-level measurement result, when determining whether to activate or deactivate the LP-WUR, whether to activate the LP-WUR may be determined based on the measurement result of the one beam with the best quality, whether to deactivate the LP-WUR may be determined based on a measurement result of one beam with the poorest quality beyond the threshold, or whether to activate or deactivate the LP-WUR may be determined based on the measurement result of the one beam with the best quality, or whether to activate or deactivate the LP-WUR may be determined based on the measurement result of the one beam with the poorest quality beyond the threshold.

In some implementations, in a case that the LP-WUR supports a plurality of reception schemes, determining, based on at least one of the second measurement result or the third measurement result, to activate one of the reception schemes or deactivate the LP-WUR may include:
in a case that at least one of the second measurement result or the third measurement result is greater than or equal to an activation threshold, determining to activate one of the reception schemes; and
in a case that at least one of the second measurement result or the third measurement result is less than a deactivation threshold, determining to deactivate the LP-WUR.

There may be one or more activation thresholds. In a case that there is one activation threshold, the plurality of reception schemes may correspond to a same activation threshold. In a case that at least one of the second measurement result or the third measurement result is greater than or equal to the activation threshold, any of the reception schemes may be selected to be activated. A specific reception scheme to be activated may be determined by the terminal, defined by a standard, or configured by the network-side device. In a case that there are a plurality of activation thresholds, different activation thresholds may correspond to different reception schemes. In a case that at least one of the second measurement result or the third measurement result is greater than or equal to a specific activation threshold, a reception scheme corresponding to the activation threshold may be determined to be activated. When determining to activate one of the reception schemes, the remaining reception schemes may be deactivated.

There may be one deactivation threshold. In a case that at least one of the second measurement result or the third measurement result is less than the deactivation threshold, it may be determined to deactivate the LP-WUR, that is, to deactivate the plurality of reception schemes supported by the LP-WUR. In some embodiments, the deactivation threshold may be less than or equal to the activation threshold.

It should be noted that at least one of the second measurement result or the third measurement result being greater than or equal to the activation threshold may be at least one of the beam-level measurement result in the second measurement result or the beam-level measurement result in the third measurement result being greater than or equal to the activation threshold, or at least one of the beam-level measurement result in the second measurement result or the cell-level measurement result in the third measurement result being greater than or equal to the activation threshold, or at least one of the cell-level measurement result in the second measurement result or the beam-level measurement result in the third measurement result being greater than or equal to the activation threshold, or at least one of the cell-level measurement result in the second measurement result or the cell-level measurement result in the third measurement result being greater than or equal to the activation threshold. Reference may be made to the foregoing implementation in which the terminal determines, based on at least one of the second measurement result or the third measurement result, to activate the LP-WUR. Details are not described herein again. Similarly, at least one of the second measurement result or the third measurement result being less than the deactivation threshold may be at least one of the beam-level measurement result in the second measurement result or the beam-level measurement result in the third measurement result being less than the deactivation threshold, or at least one of the beam-level measurement result in the second measurement result or the cell-level measurement result in the third measurement result being less than the deactivation threshold, or at least one of the cell-level measurement result in the second measurement result or the beam-level measurement result in the third measurement result being less than the deactivation threshold, or at least one of the cell-level measurement result in the second measurement result or the cell-level measurement result in the third measurement result being less than the deactivation threshold. Reference may be made to the foregoing implementation in which the terminal determines, based on at least one of the second measurement result or the third measurement result, to deactivate the LP-WUR. Details are not described herein again.

In some implementations, in a case that the plurality of reception schemes supported by the LP-WUR include the OOK reception scheme and the OFDM sequence reception, determining, based on at least one of the second measurement result or the third measurement result, to activate one of the reception schemes or deactivate the LP-WUR may include:
in a case that at least one of the second measurement result or the third measurement result is greater than or equal to a fourth threshold, determining to activate the OOK reception scheme;
in a case that at least one of the second measurement result or the third measurement result is less than the fourth threshold and greater than or equal to a fifth threshold, determining to activate the OFDM sequence reception, where the fourth threshold is greater than the fifth threshold; and
in a case that at least one of the second measurement result or the third measurement result is less than the fifth threshold, determining to deactivate the LP-WUR and enable the MR.

The fourth threshold may be an activation threshold corresponding to the OOK reception scheme, the fifth threshold may be an activation threshold corresponding to the OFDM reception scheme, and the fifth threshold may be a deactivation threshold corresponding to the LP-WUR. The fourth threshold is greater than the fifth threshold.

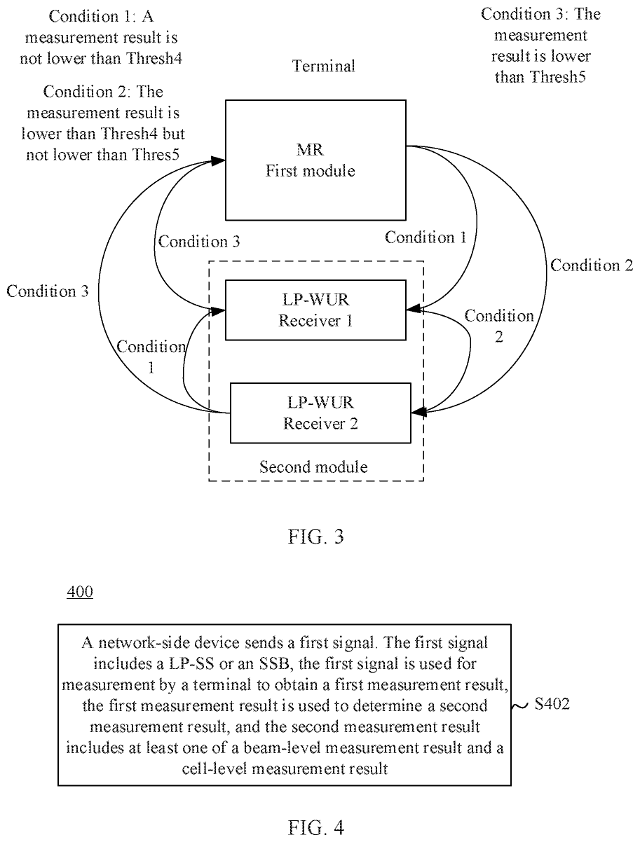

In a case that the LP-WUR supports the OOK reception scheme and the OFDM reception scheme, the terminal may switch between the OOK reception scheme and the OFDM reception scheme based on the fourth threshold and the fifth threshold and switch between the LP-WUR and the MR. For ease of understanding, reference may be made to FIG. 3.

In FIG. 3, the terminal includes a first module MR and a second module LP-WUR. The first module MR is a main communication module, and the second module LP-WUR is a low-power module. The second module includes an LP-WUR receiver 1 and an LP-WUR receiver 2. That is, the LP-WUR supports two reception schemes. The LP-WUR receiver 1 corresponds to the OOK reception scheme, and the LP-WUR receiver 2 corresponds to the OFDM reception scheme.

In FIG. 3, Condition 1 is that a measurement result is not lower than Thresh4, Condition 2 is that the measurement result is lower than Thresh4 but not less than Thresh5, and Condition 3 is that the measurement result is lower than Thresh5. The measurement result may be at least one of the second measurement result or the third measurement result. When the terminal determines to activate or deactivate the LP-WUR, if Condition 1 is satisfied, that is, the measurement result of the terminal is not lower than Thres4, the terminal may activate the LP-WUR and the LP-WUR receives a signal by using an OOK receiver. That is, the LP-WUR receiver 1 is activated. In this case, the LP-WUR receiver 2 is in the deactivated state. If Condition 2 is satisfied, that is, the measurement result of the terminal is lower than Thres4 but not lower than Thres5, the terminal may activate the LP-WUR and the LP-WUR receives a signal by using an OFDM sequence receiver. That is, the LP-WUR receiver 2 is activated. In this case, the LP-WUR receiver 1 is in the deactivated state. If Condition 3 is satisfied, that is, the measurement result of the terminal is lower than Thres5, the terminal may deactivate the LP-WUR. In this case, both the LP-WUR receiver 1 and the LP-WUR receiver 2 are in the deactivated state. In a case that the LP-WUR is deactivated, the MR may be enabled.

In some implementations, in a case that the LP-WUR supports a plurality of reception schemes, the second measurement result may be a result obtained through measurement in at least one reception scheme of the plurality of reception schemes, and the at least one reception scheme includes a reception scheme in an activated state or a reception scheme in the deactivated state. For example, in the embodiment shown in FIG. 3, if the measurement result includes the second measurement result, the second measurement result may be a result obtained through measurement by the LP-WUR receiver 1 or a result obtained through measurement by the LP-WUR receiver 2, or a combination result of results obtained through measurement by the LP-WUR receiver 1 and the LP-WUR receiver 2. During measurement, the LP-WUR receiver 1 may be in the activated state or the deactivated state (only measurement is performed and reception is not performed in the deactivated state), and the LP-WUR receiver 2 may be in the activated state or the deactivated state (only measurement is performed and reception is not performed in the deactivated state).

In some implementations, when determining to activate the LP-WUR in the manner described above, the MR in the terminal may be disabled. When determining to deactivate the LP-WUR in the manner described above, the MR in the terminal may be enabled.

In this embodiment of this application, when receiving the LP-SS or the SSB, the LP-WUR of the terminal may measure the LP-SS or the SSB, and determine, based on the measurement result, at least one of the beam-level measurement result or the cell-level measurement result. Therefore, in the multi-beam scenario, when communicating with the network-side device based on the LP-WUR, the terminal may achieve the purpose of measuring the channel quality based on the received signal. Further, after the second measurement result is obtained, it may be determined, based on at least one of the second measurement result, the power state of the terminal, or the measurement result of the SSB measured by the MR, to activate or deactivate the LP-WUR. That is, when determining to activate or deactivate the LP-WUR, the measurement results of the plurality of beams are considered. Therefore, working efficiency of the LP-WUR can be improved.

As shown in FIG. 4, an embodiment of this application provides an information measurement method 400. The method may be performed by a network-side device. In other words, the information measurement method may be performed by software or hardware installed in the network-side device. The information measurement method includes the following steps.
S402: The network-side device sends a first signal. The first signal includes an LP-SS or an SSB, the first signal is used for measurement by a terminal to obtain a first measurement result, the first measurement result is used to determine a second measurement result, and the second measurement result includes at least one of a beam-level measurement result or a cell-level measurement result.

In a multi-beam scenario, the network-side device may send the first signal to the terminal. The first signal may include the LP-SS or the SSB. After the network-side device sends the first signal to the terminal, the terminal may receive the first signal, determine the first measurement result based on the first signal, and determine the second measurement result based on the first measurement result. For an implementation in which the terminal measures the first signal to obtain the first measurement result and determines the second measurement result based on the first measurement result, reference may be made to the embodiment shown in FIG. 2. Details are not described herein again.

In some implementations, in a case that the terminal supports an LP-SS measurement and an SSB measurement by an LP-WUR, the network-side device may further send configuration information to the terminal, so that the terminal may determine, based on the configuration information, a to-be-measured signal, and measure the to-be-measured signal to obtain the first measurement result. The configuration information sent by the network-side device may be used for any one of the following:
indicating to measure the LP-SS;
indicating to measure the SSB;
indicating to measure any one of the LP-SS or the SSB;
indicating to measure the LP-SS and the SSB; or
indicating to determine the to-be-measured signal according to a first rule.

In a case that the configuration information indicates to measure the LP-SS, the terminal may measure the LP-SS. In a case that the configuration information indicates to measure the SSB, the terminal may measure the SSB. In a case that the configuration information indicates to measure any one of the LP-SS or the SSB, the terminal may determine, at its discretion, to measure the LP-SS or the SSB. In a case that the configuration information indicates to measure the LP-SS and the SSB, the terminal may measure the LP-SS and the SSB. In a case that the configuration information indicates to determine the to-be-measured signal according to the first rule, the terminal may determine the to-be-measured signal from the LP-SS and the SSB according to the first rule, and measure the to-be-measured signal. The first rule may be a predefined rule. When determining the to-be-measured signal according to the first rule, for example, if the LP-WUR of the terminal supports reception of an OFDM sequence, and an SSB available for measurement exists in an operating bandwidth of the LP-WUR (for example, an NCD-SSB is located in the operating bandwidth of the LP-WUR), the terminal may measure the SSB. Otherwise, the LP-SS may be measured.

The configuration information sent by the network-side device may be terminal-specific signaling or signaling specific to a terminal group (for example, a terminal group that supports the reception of the OFDM sequence) or cell-specific signaling. The signaling specific to the terminal group may be sent via unicast, multicast, or broadcast. The configuration information may be an explicit configuration or an implicit configuration. For example, if the network-side device configures, in system information, the LP-SS but does not configure an OFDM sequence used for the LP-SS, or does not configure the LP-SS, it may be considered that the network-side device implicitly configures that the terminal with the LP-WUR based on the reception of the OFDM sequence measures the SSB instead of the LP-SS.

In some implementations, in a case that the configuration information is used to indicate to measure the LP-SS and the SSB, the configuration information is further used to configure a first threshold and a second threshold. The first threshold is a threshold used by the terminal to activate or deactivate the LP-WUR based on a measurement result of the LP-SS, the second threshold is a threshold used by the terminal to activate or deactivate the LP-WUR based on a measurement result of the SSB, and the first threshold and the second threshold may be the same or different. For a corresponding implementation in which the terminal determines, based on a measurement result and a threshold, to activate or deactivate the LP-WUR in the terminal, reference may be made to corresponding content described in the embodiment shown in FIG. 2. Details are not described herein again.

In this embodiment of this application, the network-side device may send the LP-SS or the SSB to the terminal. When receiving the LP-SS or the SSB, the LP-WUR of the terminal may measure the LP-SS or the SSB, and determine, based on the measurement result, at least one of the beam-level measurement result or the cell-level measurement result. Therefore, in the multi-beam scenario, when communicating with the network-side device based on the LP-WUR, the terminal may achieve a purpose of measuring channel quality based on a received signal.

To facilitate understanding of an information measurement method in the multi-beam scenario provided in this embodiment of this application and how to determine, based on the measurement result, to activate or deactivate the LP-WUR in the terminal, the following uses three example embodiments as an example for description.

### Embodiment 1: LP-SS and SSB-based Measurement of LP-WUR in the Multi-Beam Scenario

To support multi-beam LP-SS transmission and reduce impact on scheduling of another NR signal, a set of LP-SS resources may be predefined by a standard or configured by a network node, including a plurality of candidate transmission occasions and a plurality of transmission occasion sets (occasion set, where one occasion set may include one or more occasions). Different beams may be used for the LP-SS transmitted by the network-side device in different occasion sets. The network-side device may select one or more occasions from a plurality of occasions in a same occasion set to transmit the LP-SS, and a same beam (with a same spatial transmission parameter) is used for the LP-SS. In some implementation, the network-side device may configure a plurality of groups of LP-SS resources, each group of LP-SS resources includes a plurality of occasions, and the plurality of occasions correspond to one occasion set. Different beams may be used for the LP-SS transmitted by the network-side device in different groups of LP-SS resources. The network-side device may select one or more occasions from a plurality of occasions in a same group of LP-SS resources to transmit the LP-SS, and a same beam is used for the LP-SS.

When receiving the LP-SS, an LP-WUR of UE may perform measurement based on the LP-SS, for example, measure RRM of a serving cell or RRM of a neighboring cell. After the measurement, the UE may generate a beam-level measurement result separately for the LP-SS in different occasion sets, or the UE generates a beam-level measurement result separately for the LP-SS in different groups of LP-SS resources. In an example embodiment, the UE may combine measurement results, within a same target time period or different target time periods, corresponding to the LP-SS in occasions in a same occasion set, and determine a combination result as the beam-level measurement result. In an example embodiment, the UE may combine measurement results, within a same target time period, corresponding to the LP-SS in occasions in a same occasion set, and determine a combination result as the beam-level measurement result, instead of combining the measurement results of the LP-SS within different target time periods. In an example embodiment, the UE may determine a measurement result, in one target time period, corresponding to the LP-SS in any occasion in a same occasion set as the beam-level measurement result, without combining the measurement result with a measurement result of another LP-SS.

The LP-WUR of the UE may perform measurement based on the SSB. The SSB may be an SSB indicated in ssb-PositionsInBurst, or an SSB configured by the network-side device for measurement performed by the LP-WUR, or an SSB to be measured that is configured when the network-side device configures SMTC. After measuring the SSB, the LP-WUR of the UE may generate a beam-level measurement result separately for SSBs with different SSB indexes. In an example embodiment, the UE may combine measurement results, in a same specific target time period or different specific target time periods, corresponding to a same SSB index, and determine a combination result as the beam-level measurement result. In an example embodiment, the UE may combine measurement results, within a same target time period or different target time periods, corresponding to a same SSB index, and determine a combination result as the beam-level measurement result. In an example embodiment, the UE may determine any one of measurement results, in one target time period, corresponding to an SSB of a same SSB index as the beam-level measurement result, without combining the measurement result with a measurement result of another SSB.

After measuring the LP-SS or the SSB and obtaining the beam-level measurement result, the UE may generate the cell-level measurement result based on the beam-level measurement result. In some embodiments, the UE may generate the cell-level measurement result in at least one of the following manners:
generating the cell-level measurement result based on a measurement result of one beam with the best quality;
generating the cell-level measurement result based on measurement results of all measured beams;
generating the cell-level measurement result based on a result of M1 beams with the best measurement result, where M1 is predefined by a standard or configured by a network node;
generating the cell-level measurement result based on results of all beams beyond a predefined threshold; or
generating the cell-level measurement result based on a result of M2 beams beyond the predefined threshold, where M2 is predefined by a standard or configured by the network-side device.

### Embodiment 2: Method for LP-WUR Activation/Deactivation in the Multi-Beam Scenario

To ensure that the LP-WUR can operate at a proper operating point, one threshold may be configured by the network-side device. When and only when link quality of the LP-WUR is not lower than the threshold or is higher than the threshold, the LP-WUR of the UE is activated, and the UE may receive an LP-WUS based on the LP-WUR and disable an MR. In addition, the UE may receive an LP-SS based on the LP-WUR to perform RRM measurement, and the MR may not perform the RRM measurement, or the MR may perform the RRM measurement. To reduce power consumption of the MR, the MR may perform a relaxed RRM measurement. For example, a period of the RRM measurement is longer. When the link quality of the LP-WUR is lower than the threshold or is not higher than the threshold, the LP-WUR of the UE is deactivated. The link quality of the LP-WUR may be represented by the measurement result of the LP-SS or the SSB measured by the LP-WUR, and/or by a measurement result of an SSB measured by the MR. The SSB measured by the MR may be the same as the SSB measured by the LP-WUR. For example, both are the SSB indicated in ssb-PositionsInBurst. In some implementations, the SSB measured by the MR may be different from the SSB measured by the LP-WUR. For example, the network-side device may configure, for the LP-WUR, an SSB to be measured, and the SSB to be measured may be a subset of the SSB indicated in ssb-PositionsInBurst.

In the multi-beam scenario, in some implementations, the UE may derive the cell-level measurement result based on the beam-level measurement result of the LP-SS or the SSB, and compare the cell-level measurement result with a predefined cell-level threshold to determine whether to activate/deactivate the LP-WUR. When one cell-level measurement result is generated based on the beam-level measurement result, the cell-level measurement result may be generated with at least one of the following methods:
generating the cell-level measurement result based on a measurement result of one beam with the best quality;
generating the cell-level measurement result based on a measurement result of one beam with the poorest quality;
generating the cell-level measurement result based on results of all measured beams;
generating the cell-level measurement result based on a result of M3 beams with the best measurement result, where M3 may be predefined by a standard or configured by the network-side device; generating the cell-level measurement result based on measurement results of all beams beyond a predefined threshold Thres2, where Thres2 is predefined by a standard or configured by the network-side device; generating the cell-level measurement result based on a result of M4 beams beyond the predefined threshold Thres2, where M4 is predefined by a standard or configured by the network-side device; or generating the cell-level measurement result based on a measurement result of one poorest beam beyond the predefined threshold Thres2.

When determining, based on the cell-level measurement result, to activate or deactivate the LP-WUR:

In an example embodiment, when determining to activate and deactivate the LP-WUR, one cell-level measurement result may be generated in a same manner, or one cell-level measurement result may be generated in different manners. For example, when determining whether to activate the LP-WUR, the cell-level measurement result may be generated based on the measurement result of the one beam with the best quality; and when determining whether to deactivate the LP-WUR, the cell-level measurement result may be generated based on the measurement result of the one beam with the poorest quality beyond the predefined threshold Thres2.

In an example embodiment, the measurement result used for determining to activate and deactivate the LP-WUR may be the measurement result in the foregoing Embodiment 1. For example, the measurement result used for determining to activate and deactivate the LP-WUR is an RSRP measurement result of the serving cell in Embodiment 1. In an example embodiment, the measurement result used for determining activation and deactivation may be different from the measurement result in Embodiment 1. For example, the cell-level measurement result is generated in different manners.

In an implementation, the UE may compare the beam-level measurement result of the LP-SS or the SSB with a predefined beam-level threshold Thres3, to determine whether to activate/deactivate the LP-WUR. Thres3 may be one threshold, applicable to each beam. In some implementations, Thres3 may be a group of thresholds, applicable to each beam. For example, the network-side device sends the LP-SS by using four different beams, and the UE derives four measurement results based on measurement of the LP-SS. The four measurement results correspond to the four beams, respectively. Thres3 is a group of thresholds, including four values corresponding to the four beams, respectively. The UE compares the measurement results of the four beams with the four thresholds to determine whether to activate or deactivate the LP-WUR. For another example, Thres3 is one threshold, the measurement results of the four beams all correspond to the one threshold, and the UE compares the measurement results of the four beams with the one threshold value to determine to activate or deactivate the LP-WUR.

When the beam-level measurement result is compared with the threshold, determining to activate/deactivate the LP-WUR may be performed with at least one of the following methods:
deactivating the LP-WUR if measurement results of at least Z1 beams are lower than a corresponding threshold or are not higher than a corresponding threshold, where when Z1>1, the measurement results of the Z1 beams are separately compared with the corresponding threshold; or, the measurement results of the Z1 beams are averaged and compared with the threshold, where Z1 is a quantity of all beams for the LP-SS or the SSB, or Z1 is configured by the network-side device; or
activating the LP-WUR if measurement results of at least Z2 beams are not lower than a corresponding threshold or are higher than a corresponding threshold, where when Z2>1, the measurement results of the Z2 beams are separately compared with the corresponding threshold; or, the measurement results of the Z2 beams are averaged and compared with the threshold, where Z2 is a quantity of all beams for the LP-SS or the SSB, or Z2 is configured by the network-side device.

Z1 and Z2 may be the same and configured together, or Z1 and Z2 may be different and configured separately.

### Embodiment 3: Method for Measurement and Activation/Deactivation When the UE Can Support a Plurality of Reception Schemes of the LP-WUR

In some implementations, the LP-WUR of the UE supports only one reception scheme, for example, supports only reception of an OOK signal (for example, an OOK-based LP-SS) in an envelope detection manner, or supports only reception of an OFDM-based sequence (for example, an SSB) in a time domain (or frequency domain) sequence detection manner. In a case that the LP-WUR of the UE supports only one reception scheme, implementation by the UE is simple.

In some other implementations, the LP-WUR of the UE may support a plurality of reception schemes, for example, support reception of an OOK signal and an OFDM sequence. It may be understood herein that modules required to support different reception schemes are different, power consumption is different, and receiving performance may be different. For example, OOK reception has lower power consumption but poorer receiving performance (corresponding to smaller coverage) than the reception of the OFDM sequence. Different reception schemes may be understood as different LP-WUR receivers. The following describes the activation/deactivation in terms of the reception scheme. The activation/deactivation may be understood as activation/deactivation of a corresponding LP-WUR receiver. In an example embodiment, different reception schemes, of the LP-WUR, used by the UE may correspond to different power saving modes.

When determining to activate or deactivate the LP-WUR, the UE may determine, based on a predefined criterion, a specific reception scheme to be activated/deactivated. The predefined criterion includes at least one of a power saving mode or a coverage area. The power saving mode may be the power state in the embodiment shown in FIG. 2, and the coverage area may be represented by the measurement result.

In an embodiment, the UE may determine, based on the measurement result and the threshold, a specific reception scheme to be activated/deactivated. For example, the network-side device configures two thresholds Thres4 and Thres5. The threshold Thres4 is a threshold for activating or deactivating a first reception scheme (taking the OOK reception as an example), the threshold Thres5 is a threshold for activating or deactivating a second reception scheme (taking the reception of the OFDM sequence as an example), and Thres4>Thres5. Therefore:
when the measurement result of the UE is not lower than Thres4, the UE may activate the LP-WUR and the LP-WUR uses the first reception scheme to receive a signal. For example, if the UE has activated the second reception scheme of the LP-WUR to receive the signal, when the measurement result is not lower than Thres4, the UE may activate the first reception scheme of the LP-WUR to receive the signal, and the UE may deactivate the second reception scheme of the LP-WUR to receive the signal. For another example, if the UE operates with the MR, when the measurement result is not lower than Thres4, the UE may activate the first reception scheme of the LP-WUR to receive the signal, and the UE may disable the MR.

When the measurement result of the UE is lower than Thres4 but not lower than Thres5, the UE may activate the second reception scheme of the LP-WUR to receive the signal. For example, if the UE has activated the first reception scheme of the LP-WUR to receive the signal, when the measurement result is lower than Thres4 but not lower than Thres5, the UE may activate the second reception scheme of the LP-WUR to receive the signal, and the UE may deactivate the first reception scheme of the LP-WUR to receive the signal. For another example, if the UE operates with the MR, when the measurement result is lower than Thres4 but not lower than Thres5, the UE may activate the second reception scheme of the LP-WUR to receive the signal, and the UE may deactivate the first reception scheme of the LP-WUR to receive the signal.

When the measurement result of the UE is lower than Thres5, the UE deactivates the LP-WUR and enables the MR. For example, if the UE has activated the second reception scheme of the LP-WUR to receive the signal, when the measurement result is lower than Thres5, the UE may deactivate the second reception scheme of the LP-WUR to receive the signal and enable the MR. For another example, if the UE has activated the first reception scheme of the LP-WUR to receive the signal, when the measurement result is lower than Thres5, the UE may deactivate the first reception scheme of the LP-WUR to receive the signal and enable the MR.

In an example embodiment, the measurement result of the UE is based on a measurement result of the MR and/or a measurement result of the LP-WUR. A threshold Thres4 for comparison with the measurement result of the MR may be different from a threshold Thres4 for comparison with the measurement result of the LP-WUR. For example, two Thres4 are configured separately. A threshold Thres5 for comparison with the measurement result of the MR may be different from a threshold Thres5 for comparison with the measurement result of the LP-WUR. For example, two Thres5 are configured separately.

In an example embodiment, the measurement result of the LP-WUR is a measurement result of the LP-SS based on the first reception scheme of the LP-WUR and/or a measurement result of the SSB or the LP-SS based on the second reception scheme of the LP-WUR.

In an example embodiment, the MR may perform measurement when the MR is disabled.

In an example embodiment, when an X^{th} reception scheme of the LP-WUR is in a deactivated state, the X^{th} reception scheme of the LP-WUR is not used for measurement. For example, if the second reception scheme of the LP-WUR is not activated, the UE does not measure the SSB or the LP-SS in the second reception scheme of the LP-WUR. In an example embodiment, when the X^{th} reception scheme of the LP-WUR is in a deactivated state, the X^{th} reception scheme of the LP-WUR may be used for measurement.

In an example embodiment, the measurement result, of the LP-WUR, used to determine whether to activate the X^{th} reception scheme is a measurement result of the LP-WUR based on the X^{th} reception scheme. In some embodiments, the measurement result, of the LP-WUR, used to determine whether to activate the X^{th} (X^{th} is first or second) reception scheme is a measurement result of the LP-WUR based on the first reception scheme and/or a measurement result of the LP-WUR based on the second reception scheme.

In an embodiment, the UE operates with the MR, and a measurement result of the UE based on the MR is compared with Thres4 and Thres5. If the measurement result is not lower than Thres4, the first reception scheme of the LP-WUR is activated. If the measurement result is lower than Thres4 but not lower than Thres5, the second reception scheme of the LP-WUR is activated. Otherwise, the LP-WUR is not activated, and the UE still operates only with the MR.

In an embodiment, if the first reception scheme of the LP-WUR has been activated, the measurement result of the UE based on the MR and/or the measurement result of the LP-WUR based on the first reception scheme are/is compared with the threshold. If the measurement result is lower than Thres4 but not lower than Thres5, the second reception scheme of the LP-WUR is activated. If the measurement result is lower than Thres5, the LP-WUR is deactivated to return to the MR. In some embodiments, if the measurement result is lower than Thres4, the measurement result of the LP-WUR based on the second reception scheme is further compared with the threshold to determine to activate the second reception scheme of the LP-WUR or deactivate the LP-WUR to return to the MR.

In an embodiment, if the second reception scheme of the LP-WUR has been activated, the measurement result of the UE based on the MR and/or the measurement result of the LP-WUR based on the second reception scheme are/is compared with the threshold to determine activation/deactivation of the LP-WUR (including a specific reception scheme of the LP-WUR).

In an embodiment, the measurement result of the UE based on the MR and/or the measurement result of the LP-WUR based on the second reception scheme and/or the measurement result of the LP-WUR based on the first reception scheme are/is compared with the threshold to determine the activation/deactivation of the LP-WUR (including a specific reception scheme of the LP-WUR).

In an embodiment, the UE may select a proper power saving mode based on a power state of the UE, for example, being in a low battery state or a normal battery state. For example, when the UE is in the low battery state, the LP-WUR can operate only in the first reception scheme.

In the multi-beam scenario, Thres4 and/or Thres5 may be a beam-level threshold or a cell-level threshold. The UE compares a beam-level measurement result of the LP-WUR with the beam-level threshold, or the UE derives a cell-level measurement result based on the beam-level measurement result of the LP-WUR and compares the cell-level measurement result with the cell-level threshold, to determine to activate/deactivate the reception scheme of the LP-WUR.

Based on the foregoing Embodiment 1 to Embodiment 3, in the multi-beam scenario, the network-side device may flexibly implement beam sweeping of the LP-SS, and the LP-WUR performs beam-level measurement on the LP-SS and derives the cell-level measurement result, to implement RRM measurement of an offload MR. In addition, working efficiency of the LP-WUR can be improved because results of a plurality of beams are considered in the activation/deactivation of the LP-WUR.

The information measurement method provided in embodiments of this application may be performed by an information measurement apparatus. In embodiments of this application, an example in which the information measurement apparatus performs the information measurement method is used to describe the information measurement apparatus provided in embodiments of this application.

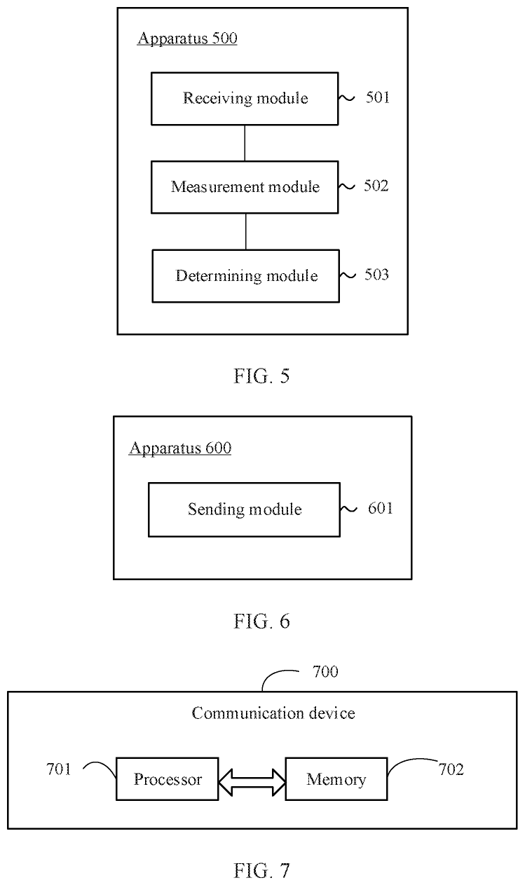

FIG. 5 is a diagram of a structure of an information measurement apparatus according to an embodiment of this application. The apparatus may correspond to a terminal in another embodiment. As shown in FIG. 5, the apparatus 500 includes the following modules.

A receiving module 501 is configured to receive a first signal, where the first signal includes a low-power synchronization signal LP-SS or a synchronization signal block SSB.

A measurement module 502 is configured to measure the first signal to obtain a first measurement result.

A determining module 503 is configured to determine a second measurement result based on the first measurement result, where the second measurement result includes at least one of a beam-level measurement result or a cell-level measurement result.

In some implementations, the measurement module 502 is configured for any one of the following:
in a case that the terminal supports an LP-SS measurement by an LP-WUR, measuring the LP-SS;
in a case that the terminal supports an SSB measurement by an LP-WUR, measuring the SSB; or
in a case that the terminal supports an LP-SS measurement and an SSB measurement by an LP-WUR, determining a to-be-measured signal from the LP-SS and the SSB based on configuration information of a network-side device; and measuring the to-be-measured signal; where in a case that the LP-WUR supports an orthogonal frequency division multiplexing OFDM sequence reception or supports an OFDM sequence reception and an on-off keying OOK reception scheme, the terminal supports the LP-SS measurement and the SSB measurement.

In some implementations, the configuration information is used for any one of the following:
indicating to measure the LP-SS;
indicating to measure the SSB;
indicating to measure any one of the LP-SS or the SSB;
indicating to measure the LP-SS and the SSB; or
indicating to determine the to-be-measured signal according to a first rule.

In some implementations, in a case that the configuration information is used to indicate to measure the LP-SS and the SSB, the configuration information is further used to configure a first threshold and a second threshold.

The first threshold is a threshold used by the terminal to activate or deactivate the LP-WUR based on a measurement result of the LP-SS, the second threshold is a threshold used by the terminal to activate or deactivate the LP-WUR based on a measurement result of the SSB, and the first threshold and the second threshold are the same or different.

In some implementations, the first measurement result and the second measurement result include a channel quality measurement result of a cell, the channel quality measurement result of the cell includes at least one of a radio link monitoring RLM measurement result, a radio resource management RRM measurement result, or a channel state information CSI measurement result, and the cell includes at least one of a serving cell or a neighboring cell.

In some implementations, the determining module 503 is configured for at least one of the following:
determining the beam-level measurement result based on the first measurement result; or
determining the cell-level measurement result based on the beam-level measurement result.

In some implementations, in a case that the first signal includes the LP-SS, the first measurement result includes measurement results corresponding to different transmission occasion sets or a measurement result corresponding to an LP-SS of an LP-SS index. The determining module 503 is configured for any one of the following:
combining measurement results of the LP-SS in a first transmission occasion, and determining a combination result as the beam-level measurement result, where the first transmission occasion is a transmission occasion, within different target time periods, corresponding to a same transmission occasion set;
combining measurement results of the LP-SS in second transmission occasions, and determining a combination result as the beam-level measurement result, where the second transmission occasions are transmission occasions, within a same target time period, corresponding to a same transmission occasion set;
determining a measurement result of the LP-SS in a third transmission occasion as the beam-level measurement result, where the third transmission occasion is any one of transmission occasions, within a same target time period, corresponding to a same transmission occasion set;
combining measurement results, within different target time periods, corresponding to an LP-SS of a same LP-SS index, and determining a combination result as the beam-level measurement result;
combining measurement results, within a same target time period, corresponding to an LP-SS of a same LP-SS index, and determining a combination result as the beam-level measurement result; or
determining a measurement result, within a same target time period, corresponding to an LP-SS of a same LP-SS index as the beam-level measurement result.

In some implementations, in a case that the first signal includes the SSB, the first measurement result includes a measurement result corresponding to an SSB of an SSB index. The determining module 503 is configured for any one of the following:
combining measurement results, within different target time periods, corresponding to an SSB of a same SSB index, and determining a combination result as the beam-level measurement result;
combining measurement results, within a same target time period, corresponding to an SSB of a same SSB index, and determining a combination result as the beam-level measurement result; or
determining any one of measurement results, within a same target time period, corresponding to an SSB of a same SSB index as the beam-level measurement result.

In some implementations, the determining module 503 is configured for at least one of the following:
determining a measurement result of a beam with the best beam quality as the cell-level measurement result;
determining a measurement result of a beam with the poorest beam quality as the cell-level measurement result;
determining measurement results of a plurality of beams as the cell-level measurement result;
determining a measurement result of M1 beams with the best beam quality as the cell-level measurement result;
determining a measurement result of a beam whose beam quality is greater than a third threshold as the cell-level measurement result;
determining a measurement result of M2 beams whose beam quality is greater than the third threshold as the cell-level measurement result; or
determining a measurement result of a beam with the poorest beam quality in beams whose beam quality is greater than the third threshold as the cell-level measurement result.

In some implementations, the determining module 503 is further configured to:
determine, based on at least one of a power state, the second measurement result, and a third measurement result, to activate or deactivate the LP-WUR in the terminal. The third measurement result includes a measurement result of the SSB measured by a main radio MR in the terminal.

The measurement result of the SSB includes at least one of a beam-level measurement result or a cell-level measurement result, the measurement result of the SSB includes a channel quality measurement result of a cell, the channel quality measurement result of the cell includes at least one of an RLM measurement result, an RRM measurement result, or a CSI measurement result, and the cell includes at least one of a serving cell and a neighboring cell.

In some implementations, the LP-WUR supports one or more reception schemes. The determining module 503 is configured to:
in a case that the LP-WUR supports one reception scheme, determine, based on at least one of the power state, the second measurement result, and the third measurement result, to activate or deactivate the LP-WUR; and
in a case that the LP-WUR supports a plurality of reception schemes, determine, based on at least one of the power state, the second measurement result, and the third measurement result, to activate one of the reception schemes or deactivate the LP-WUR.

In some implementations, the plurality of reception schemes include at least the OOK reception scheme and the OFDM sequence reception.

In some implementations, the determining module 503 is configured to:
in a case that at least one of the second measurement result and the third measurement result is greater than or equal to an activation threshold, determine to activate one of the reception schemes; and
in a case that at least one of the second measurement result and the third measurement result is less than a deactivation threshold, determine to deactivate the LP-WUR, where
different reception schemes correspond to different activation thresholds; and when determining to activate one of the reception schemes, deactivate the remaining reception schemes.

In some implementations, the determining module 503 is configured to:
in a case that at least one of the second measurement result and the third measurement result is greater than or equal to a fourth threshold, determine to activate the OOK reception scheme;
in a case that at least one of the second measurement result and the third measurement result is less than the fourth threshold and greater than or equal to a fifth threshold, determine to activate the OFDM sequence reception, where the fourth threshold is greater than the fifth threshold; and
in a case that at least one of the second measurement result and the third measurement result is less than the fifth threshold, determine to deactivate the LP-WUR and enable the MR.

In some implementations, in a case that the LP-WUR supports a plurality of reception schemes, the second measurement result is a result obtained through measurement in at least one reception scheme, and the at least one reception scheme includes a reception scheme in an activated state or a reception scheme in the deactivated state.

In some implementations, the determining module 503 is configured for at least one of the following:
determining, based on at least one of the beam-level measurement result in the second measurement result and a beam-level measurement result in the third measurement result, to activate or deactivate the LP-WUR;
determining, based on at least one of the beam-level measurement result in the second measurement result and a cell-level measurement result in the third measurement result, to activate or deactivate the LP-WUR;
determining, based on at least one of the cell-level measurement result in the second measurement result and the beam-level measurement result in the third measurement result, to activate or deactivate the LP-WUR; and
determining, based on at least one of the cell-level measurement result in the second measurement result and the cell-level measurement result in the third measurement result, to activate or deactivate the LP-WUR.

In some implementations, the determining module 503 is configured to:
in a case that the beam-level measurement result in the second measurement result is greater than or equal to a sixth threshold or the beam-level measurement result in the third measurement result is greater than or equal to a seventh threshold, determine to activate the LP-WUR; and
in a case that the beam-level measurement result in the second measurement result is less than an eighth threshold or the third measurement result is less than a ninth threshold, determine to deactivate the LP-WUR.

The sixth threshold and the eighth threshold are the same or different, and the seventh threshold and the ninth threshold are the same or different. There are a plurality of manners of determining the beam-level measurement result in the second measurement result. A manner of determining the beam-level measurement result used for determining, based on the beam-level measurement result in the second measurement result, to activate the LP-WUR and a manner of determining the beam-level measurement result used for determining, based on the beam-level measurement result in the second measurement result, to deactivate the LP-WUR are the same or different. There are a plurality of manners of determining the beam-level measurement result in the third measurement result. A manner of determining the beam-level measurement result used for determining, based on the beam-level measurement result in the third measurement result, to activate the LP-WUR and a manner of determining the beam-level measurement result used for determining, based on the beam-level measurement result in the third measurement result, to deactivate the LP-WUR are the same or different.

In some implementations, the determining module 503 is further configured to:
when activating the LP-WUR, disable the MR; and
when deactivating the LP-WUR, enable the MR.

The apparatus 500 according to this embodiment of this application may correspond to the procedures of the method 200 in the embodiment of this application, and units/modules in the apparatus 500 and the foregoing other operations and/or functions are separately for implementing the corresponding procedures of the method 200, and can achieve a same or equivalent technical effect. For brevity, details are not described herein again.

FIG. 6 is a diagram of a structure of an information measurement apparatus according to an embodiment of this application. The apparatus may correspond to a network-side device in another embodiment. As shown in FIG. 6, the apparatus 600 includes the following module.

A sending module 601 is configured to send a first signal.

The first signal includes an LP-SS or an SSB, the first signal is used for measurement by a terminal to obtain a first measurement result, the first measurement result is used to determine a second measurement result, and the second measurement result includes at least one of a beam-level measurement result and a cell-level measurement result.

In some implementations, the sending module 601 is further configured to:
send configuration information to the terminal, where the configuration information is used for any one of the following:
indicating to measure the LP-SS;
indicating to measure the SSB;
indicating to measure any one of the LP-SS and the SSB;
indicating to measure the LP-SS and the SSB; and
indicating to determine a to-be-measured signal according to a first rule.

In some implementations, in a case that the configuration information is used to indicate to measure the LP-SS and the SSB, the configuration information is further used to configure a first threshold and a second threshold.

The first threshold is a threshold used by the terminal to activate or deactivate the LP-WUR based on a measurement result of the LP-SS, the second threshold is a threshold used by the terminal to activate or deactivate the LP-WUR based on a measurement result of the SSB, and the first threshold and the second threshold are the same or different.

The apparatus 600 according to this embodiment of this application may correspond to the procedures of the method 400 in the embodiment of this application, and units/modules in the apparatus 600 and the foregoing other operations and/or functions are separately for implementing the corresponding procedures of the method 400, and can achieve a same or equivalent technical effect. For brevity, details are not described herein again.

The information measurement apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but not be limited to the foregoing listed types of the terminal 11, and the another device may be a server, a Network Attached Storage (NAS), or the like. This is not specifically limited in this embodiment of this application.

The information measurement apparatus provided in this embodiment of this application can implement the processes implemented in the method embodiment from FIG. 2 to FIG. 4, and a same technical effect can be achieved. To avoid repetition, details are not described herein again.

As shown in FIG. 7, an embodiment of this application further provides a communication device 700, including a processor 701 and a memory 702. The memory 702 stores a program or instructions that can be run on the processor 701. For example, when the communication device 700 is a terminal, the program or the instructions are executed by the processor 701 to implement the steps of the foregoing information measurement method embodiment, and a same technical effect can be achieved. When the communication device 700 is a network-side device, the program or the instructions are executed by the processor 701 to implement the steps of the foregoing information measurement method embodiment, and a same technical effect can be achieved. To avoid repetition, details are not described herein again.

An embodiment of this application further provides a terminal, including a processor and a communication interface. The communication interface is coupled to the processor. The processor is configured to run a program or instructions to implement the steps of the method embodiment shown FIG. 2. The terminal embodiment is corresponding to the method embodiment on the terminal side, each implementation process and implementation of the method embodiment can be applied to the terminal embodiment, and a same technical effect can be achieved. In an example embodiment, FIG. 8 is a diagram of a structure of hardware of a terminal for implementing an embodiment of this application.

The terminal 800 includes but is not limited to at least a part of components such as a radio frequency unit 801, a network module 802, an audio output unit 803, an input unit 804, a sensor 805, a display unit 806, a user input unit 807, an interface unit 808, a memory 809, and a processor 810.

It can be understood by a person skilled in the art that the terminal 800 may further include a power supply (for example, a battery) that supplies power to each component. The power supply may be logically connected to the processor 810 by using a power management system, so that functions such as charge and discharge management and power consumption management are implemented by using the power management system. The terminal structure shown in FIG. 8 constitutes no limitation on the terminal, and the terminal may include more or fewer components than those shown in the figure, or combine some components, or have different component arrangements. Details are not described herein again.

It should be understood that, in this embodiment of this application, the input unit 804 may include a Graphics Processing Unit (GPU) 8041 and a microphone 8042, and the graphics processing unit 8041 processes image data of a still picture or a video obtained by an image capture apparatus (such as a camera) in a video capture mode or an image capture mode. The display unit 806 may include a display panel 8061, and the display panel 8061 may be configured in a form of a liquid crystal display, an organic light-emitting diode, or the like. The user input unit 807 includes at least one of a touch panel 8071 and another input device 8072. The touch panel 8071 is also referred to as a touchscreen. The touch panel 8071 may include two parts: a touch detection apparatus and a touch controller. The another input device 8072 may include but not be limited to a physical keyboard, a functional button (such as a volume control button or a power on/off button), a trackball, a mouse, and a joystick. Details are not described herein again.

In this embodiment of this application, after receiving downlink data from a network-side device, the radio frequency unit 801 may transmit the downlink data to the processor 810 for processing. In addition, the radio frequency unit 801 may send uplink data to the network-side device. Generally, the radio frequency unit 801 includes but is not limited to an antenna, an amplifier, a transceiver, a coupler, a low noise amplifier, a duplexer, and the like.

The memory 809 may be configured to store a software program or instructions and various data. The memory 809 may mainly include a first storage area for storing a program or instructions and a second storage area for storing data. The first storage area may store an operating system, and an application or instructions required by at least one function (for example, a sound playback function or an image playback function). In addition, the memory 809 may include a volatile memory or a nonvolatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 809 in this embodiment of this application includes but is not limited to these memories and any memory of another proper type.

The processor 810 may include one or more processing units. In some implementations, an application processor and a modem processor are integrated into the processor 810. The application processor mainly processes an operating system, a user interface, an application, or the like. The modem processor mainly processes a wireless communication signal, for example, a baseband processor. It may be understood that the modem processor may not be integrated into the processor 810.

The radio frequency unit 801 is configured to receive a first signal. The first signal includes a low-power synchronization signal LP-SS or a synchronization signal block SSB. The processor 810 is configured to measure the first signal to obtain a first measurement result, and determine a second measurement result based on the first measurement result. The second measurement result includes at least one of a beam-level measurement result and a cell-level measurement result.

In this embodiment of this application, when receiving the LP-SS or the SSB, the terminal may measure the LP-SS or the SSB, and determine, based on a measurement result, at least one of the beam-level measurement result and the cell-level measurement result. Therefore, in the multi-beam scenario, when communicating with the network-side device based on the LP-WUR, the terminal may achieve a purpose of measuring channel quality based on a received signal.

It can be understood that, for an implementation process of the implementations mentioned in this embodiment, reference may be made to the related descriptions in the method embodiment 200, and a same or corresponding technical effect is achieved. To avoid repetition, details are not described herein again.

An embodiment of this application further provides a network-side device, including a processor and a communication interface, where the communication interface is coupled to the processor, and the processor is configured to run a program or instructions to implement the steps of the method embodiment shown in FIG. 4. This network-side device embodiment corresponds to the foregoing method embodiment of the network-side device. Each implementation process and implementation of the foregoing method embodiment may be applicable to this network-side device embodiment, and a same technical effect can be achieved.

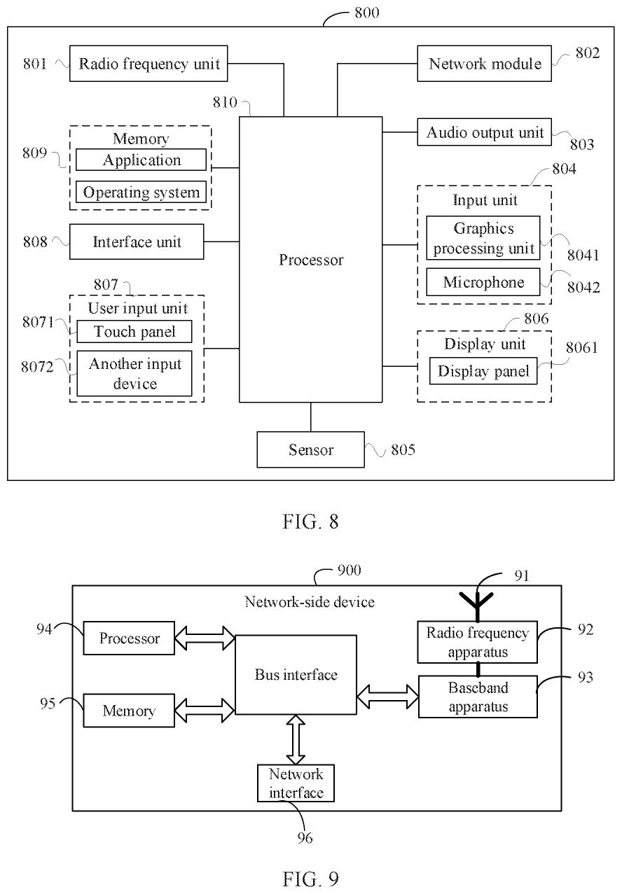

An embodiment of this application further provides a network-side device. As shown in FIG. 9, the network-side device 900 includes an antenna 91, a radio frequency apparatus 92, a baseband apparatus 93, a processor 94, and a memory 95. The antenna 91 is connected to the radio frequency apparatus 92. In an uplink direction, the radio frequency apparatus 92 receives information through the antenna 91, and sends the received information to the baseband apparatus 93 for processing. In a downlink direction, the baseband apparatus 93 processes information that needs to be sent, and sends processed information to the radio frequency apparatus 92. The radio frequency apparatus 92 processes the received information, and sends processed information through the antenna 91.

In the foregoing embodiment, the method performed by the network-side device may be implemented in the baseband apparatus 93. The baseband apparatus 93 includes a baseband processor.

For example, the baseband apparatus 93 may include at least one baseband board. A plurality of chips are disposed on the baseband board. As shown in FIG. 9, one of the chips is, for example, a baseband processor, and is connected to the memory 95 by using a bus interface, to invoke a program in the memory 95 to perform the operations of the network device shown in the foregoing method embodiment.

The network-side device may further include a network interface 96, and the interface is, for example, a Common Public Radio Interface (CPRI).

The network-side device 900 in this embodiment of this application further includes instructions or a program that is stored in the memory 95 and that can be run on the processor 94. The processor 94 invokes the instructions or the program in the memory 95 to perform the method performed by the modules shown in FIG. 4, and a same technical effect is achieved. To avoid repetition, details are not described herein again.

An embodiment of this application further provides a readable storage medium. The readable storage medium stores a program or instructions, and the program or the instructions are executed by a processor to implement the processes of the foregoing information measurement method embodiment, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transitory readable storage medium.

An embodiment of this application further provides a chip. The chip includes a processor and a communication interface, the communication interface is coupled to the processor, and the processor is configured to run a program or instructions to implement the processes of the foregoing information measurement method embodiment, and a same technical effect can be achieved. To avoid repetition, details are not described herein again.

It should be understood that the chip mentioned in this embodiment of this application may also be referred to as a system-level chip, a system chip, a chip system, a system on chip, or the like.

An embodiment of this application further provides a computer program/program product. The computer program/program product is stored in a storage medium, and the computer program/program product is executed by at least one processor to implement the processes of the foregoing information measurement method embodiment, and a same technical effect can be achieved. To avoid repetition, details are not described herein again.

An embodiment of this application further provides an information measurement system, including a terminal and a network-side device. The terminal may be configured to perform the steps of the information measurement method shown in FIG. 2, and the network-side device may be configured to perform the steps of the information measurement method shown in FIG. 4.

It should be noted that, in this specification, the term “include”, “comprise”, or any other variant thereof is intended to cover a non-exclusive inclusion, so that a process, a method, an article, or an apparatus that includes a series of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product in addition to a necessary universal hardware platform or by hardware. The computer software product is stored in a storage medium (such as a ROM, a RAM, a magnetic disk, or an optical disc), and includes several instructions for instructing a terminal or a network-side device to perform the methods described in embodiments of this application.

Embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms of implementations without departing from the purpose of this application and the protection scope of the claims, all of which fall within the protection of this application.

1. A method of information measurement, comprising:
receiving, by a low-power wake-up receiver (LP-WUR) of a terminal, a first signal, wherein the first signal comprises a low-power synchronization signal (LP-SS) or a synchronization signal block (SSB);
measuring, by the terminal, the first signal to obtain a first measurement result; and
determining, by the terminal, a second measurement result based on the first measurement result, wherein the second measurement result comprises at least one of a beam-level measurement result or a cell-level measurement result.

2. The method according to claim 1, wherein measuring, by the terminal, the first signal comprises any one of the following:
when the terminal supports an LP-SS measurement by the LP-WUR, measuring the LP-SS;
when the terminal supports an SSB measurement by the LP-WUR, measuring the SSB; or
when the terminal supports an LP-SS measurement and an SSB measurement by the LP-WUR, determining a to-be-measured signal from the LP-SS and the SSB based on configuration information of a network-side device; and measuring the to-be-measured signal; wherein when the LP-WUR supports an orthogonal frequency division multiplexing (OFDM) sequence reception or supports an OFDM sequence reception and an on-off keying (OOK) reception scheme, the terminal supports the LP-SS measurement and the SSB measurement by the LP-WUR.

3. The method according to claim 2, wherein the configuration information is used for any one of the following:
indicating to measure the LP-SS;
indicating to measure the SSB;
indicating to measure any one of the LP-SS or the SSB;
indicating to measure the LP-SS and the SSB; or
indicating to determine the to-be-measured signal according to a first rule.

4. The method according to claim 3, wherein when the configuration information is used to indicate to measure the LP-SS and the SSB, the configuration information is further used to configure a first threshold and a second threshold; and
the first threshold is a threshold used by the terminal to activate or deactivate the LP-WUR based on a measurement result of the LP-SS, the second threshold is a threshold used by the terminal to activate or deactivate the LP-WUR based on a measurement result of the SSB, and the first threshold and the second threshold are the same or different.

5. The method according to claim 1, wherein the first measurement result and the second measurement result comprise a channel quality measurement result of a cell, the channel quality measurement result of the cell comprises at least one of a radio link monitoring (RLM) measurement result, a radio resource management (RRM) measurement result, or a channel state information (CSI) measurement result, and the cell comprises at least one of a serving cell or a neighboring cell.

6. The method according to claim 1, wherein determining, by the terminal, the second measurement result based on the first measurement result comprises at least one of the following:
determining the beam-level measurement result based on the first measurement result; or
determining the cell-level measurement result based on the beam-level measurement result.

7. The method according to claim 6, wherein when the first signal comprises the LP-SS, the first measurement result comprises measurement results corresponding to different transmission occasion sets or a measurement result corresponding to an LP-SS of an LP-SS index; wherein determining the beam-level measurement result based on the first measurement result comprises any one of the following:
combining measurement results of the LP-SS in first transmission occasions, and determining a combination result as the beam-level measurement result, wherein the first transmission occasions are transmission occasions, within different target time periods, corresponding to a same transmission occasion set;
combining measurement results of the LP-SS in second transmission occasions, and determining a combination result as the beam-level measurement result, wherein the second transmission occasions are transmission occasions, within a same target time period, corresponding to a same transmission occasion set;
determining a measurement result of the LP-SS in a third transmission occasion as the beam-level measurement result, wherein the third transmission occasion is any one of transmission occasions, within a same target time period, corresponding to a same transmission occasion set;
combining measurement results, within different target time periods, corresponding to an LP-SS of a same LP-SS index, and determining a combination result as the beam-level measurement result;
combining measurement results, within a same target time period, corresponding to an LP-SS of a same LP-SS index, and determining a combination result as the beam-level measurement result; or
determining any one of measurement results, within a same target time period, corresponding to an LP-SS of a same LP-SS index as the beam-level measurement result.

8. The method according to claim 6, wherein when the first signal comprises the SSB, the first measurement result comprises a measurement result corresponding to an SSB of an SSB index; wherein determining the beam-level measurement result based on the first measurement result comprises any one of the following:
combining measurement results, within different target time periods, corresponding to an SSB of a same SSB index, and determining a combination result as the beam-level measurement result;
combining measurement results, within a same target time period, corresponding to an SSB of a same SSB index, and determining a combination result as the beam-level measurement result; or
determining any one of measurement results, within a same target time period, corresponding to an SSB of a same SSB index as the beam-level measurement result.

9. The method according to claim 6, wherein determining the cell-level measurement result based on the beam-level measurement result comprises any one of the following:
determining a measurement result of a beam with the best beam quality as the cell-level measurement result;
determining a measurement result of a beam with the poorest beam quality as the cell-level measurement result;
determining measurement results of a plurality of beams as the cell-level measurement result;
determining a measurement result of M1 beams with the best beam quality as the cell-level measurement result;
determining a measurement result of a beam whose beam quality is greater than a third threshold as the cell-level measurement result;
determining a measurement result of M2 beams whose beam quality is greater than the third threshold as the cell-level measurement result; or
determining a measurement result of a beam with the poorest beam quality in beams whose beam quality is greater than the third threshold as the cell-level measurement result.

10. The method according to claim 1, further comprising:
determining, by the terminal based on at least one of a power state, the second measurement result, and a third measurement result, to activate or deactivate the LP-WUR in the terminal, wherein the third measurement result comprises a measurement result of the SSB measured by a main radio (MR) in the terminal; and
the measurement result of the SSB comprises at least one of a beam-level measurement result and a cell-level measurement result, the measurement result of the SSB comprises a channel quality measurement result of a cell, the channel quality measurement result of the cell comprises at least one of an RLM measurement result, an RRM measurement result, or a CSI measurement result, and the cell comprises at least one of a serving cell or a neighboring cell.

11. The method according to claim 10, wherein the LP-WUR supports one or more reception schemes; and determining, by the terminal based on at least one of the power state, the second measurement result, or the third measurement result, to activate or deactivate the LP-WUR in the terminal comprises:
when the LP-WUR supports one reception scheme, determining, based on at least one of the power state, the second measurement result, or the third measurement result, to activate or deactivate the LP-WUR; and
when the LP-WUR supports a plurality of reception schemes, determining, based on at least one of the power state, the second measurement result, or the third measurement result, to activate one of the reception schemes or deactivate the LP-WUR.

12. The method according to claim 11, wherein the plurality of reception schemes comprise at least an on-off keying (OOK) reception scheme and an orthogonal frequency division multiplexing (OFDM) sequence reception.

13. The method according to claim 11, determining, based on at least one of the second measurement result or the third measurement result, to activate one of the reception schemes or deactivate the LP-WUR comprises:
when at least one of the second measurement result or the third measurement result is greater than or equal to an activation threshold, determining to activate one of the reception schemes; and
when at least one of the second measurement result or the third measurement result is less than a deactivation threshold, determining to deactivate the LP-WUR,
wherein different reception schemes correspond to different activation thresholds; and
when determining to activate one of the reception schemes, deactivating the remaining reception schemes.

14. The method according to claim 11, wherein when the plurality of reception schemes comprise an on-off keying (OOK) reception scheme and an orthogonal frequency division multiplexing (OFDM) sequence reception, determining, based on at least one of the second measurement result or the third measurement result, to activate one of the reception schemes or deactivate the LP-WUR comprises:
when at least one of the second measurement result or the third measurement result is greater than or equal to a fourth threshold, determining to activate the OOK reception scheme;
when at least one of the second measurement result or the third measurement result is less than the fourth threshold and greater than or equal to a fifth threshold, determining to activate the OFDM sequence reception, wherein the fourth threshold is greater than the fifth threshold; and
when at least one of the second measurement result or the third measurement result is less than the fifth threshold, determining to deactivate the LP-WUR and enable the MR.

15. The method according to claim 11, wherein when the LP-WUR supports a plurality of reception schemes, the second measurement result is a result obtained through measurement in at least one reception scheme, and the at least one reception scheme comprises a reception scheme in an activated state or a reception scheme in a deactivated state.

16. The method according to claim 10, wherein determining, by the terminal based on at least one of the second measurement result or the third measurement result, to activate or deactivate the LP-WUR comprises at least one of the following:
determining, based on at least one of the beam-level measurement result in the second measurement result or a beam-level measurement result in the third measurement result, to activate or deactivate the LP-WUR;
determining, based on at least one of the beam-level measurement result in the second measurement result or a cell-level measurement result in the third measurement result, to activate or deactivate the LP-WUR;
determining, based on at least one of the cell-level measurement result in the second measurement result or the beam-level measurement result in the third measurement result, to activate or deactivate the LP-WUR; or
determining, based on at least one of the cell-level measurement result in the second measurement result or the cell-level measurement result in the third measurement result, to activate or deactivate the LP-WUR.

17. The method according to claim 16, wherein determining, based on at least one of the beam-level measurement result in the second measurement result or the beam-level measurement result in the third measurement result, to activate or deactivate the LP-WUR comprises:
when the beam-level measurement result in the second measurement result is greater than or equal to a sixth threshold or the beam-level measurement result in the third measurement result is greater than or equal to a seventh threshold, determining to activate the LP-WUR; and
when the beam-level measurement result in the second measurement result is less than an eighth threshold or the beam-level measurement result in the third measurement result is less than a ninth threshold, determining to deactivate the LP-WUR, wherein
the sixth threshold and the eighth threshold are the same or different, and the seventh threshold and the ninth threshold are the same or different; there are a plurality of manners of determining the beam-level measurement result in the second measurement result, and a manner of determining the beam-level measurement result used for determining, based on the beam-level measurement result in the second measurement result, to activate the LP-WUR and a manner of determining the beam-level measurement result used for determining, based on the beam-level measurement result in the second measurement result, to deactivate the LP-WUR are the same or different; and there are a plurality of manners of determining the beam-level measurement result in the third measurement result, and a manner of determining the beam-level measurement result used for determining, based on the beam-level measurement result in the third measurement result, to activate the LP-WUR and a manner of determining the beam-level measurement result used for determining, based on the beam-level measurement result in the third measurement result, to deactivate the LP-WUR are the same or different.

18. The method according to claim 10, further comprising:
when activating the LP-WUR, disabling the MR; and
when deactivating the LP-WUR, enabling the MR.

19. A terminal, comprising: a memory storing a computer program; and a processor coupled to the memory and configured to execute the computer program to perform operations comprising:
receiving, by a low-power wake-up receiver (LP-WUR) of the terminal, a first signal, wherein the first signal comprises a low-power synchronization signal (LP-SS) or a synchronization signal block (SSB);
measuring, by the terminal, the first signal to obtain a first measurement result; and
determining, by the terminal, a second measurement result based on the first measurement result, wherein the second measurement result comprises at least one of a beam-level measurement result or a cell-level measurement result.

20. A non-transitory computer-readable storage medium, storing a computer program, wherein the computer program, when executed by a processor of (a terminal/electronic device), causes the processor to perform operations comprising:
receiving, by a low-power wake-up receiver (LP-WUR) of a terminal, a first signal, wherein the first signal comprises a low-power synchronization signal (LP-SS) or a synchronization signal block (SSB);
measuring, by the terminal, the first signal to obtain a first measurement result; and
determining, by the terminal, a second measurement result based on the first measurement result, wherein the second measurement result comprises at least one of a beam-level measurement result or a cell-level measurement result.
